(19) United States
(12) Patent Application Publication
(10) Pub. No.: US 2020/0398984 A1
(43) Pub. Date: Dec. 24, 2020

(54) Extended Drone Range

(71) Applicant: Jocelyn Bruno, Cibolo, TX (US)

(72) Inventor: Jocelyn Bruno, Cibolo, TX (US)

(21) Appl. No.: 16/660,113

(22) Filed: Oct. 22, 2019

Related U.S. Application Data
(60) Provisional application No. 62/922,970, filed on Sep. 10, 2019.

(51) Int. Cl. B64C 37/02; B64C 39/02; B64D 5/00; B64D 1/02; G05D 1/10

(52) U.S. Cl. CPC B64C 37/02; B64C 39/022; B64C 39/024; B64D 5/00; B64C 2201/143; G05D 1/104; B64C 2201/06; B64C 2201/044; B64C 2201/082; B64D 1/02

(57) ABSTRACT

Disclosed is a drone system and method for connecting drone aircraft in flight via connecting rods mounted to the drone aircraft. This allows a group of drone aircraft to significantly extend their range by temporarily turning off the engines of one or more of the drone aircraft in flight while connected via the connecting rods.

### CROSS REFERENCE TO RELATED APPLICATIONS

This application claims priority under 35 USC § 119(e) to U.S. provisional application No. 62/922,970 filed on Sep. 10, 2019 which application is herein incorporated by reference in its entirety.

### BACKGROUND OF THE DISCLOSURE

### Field of the Invention

This disclosure is generally directed to unmanned drone aircraft, and more specifically, systems and methods of connecting the aircraft in flight in methods to extend their range.

Directed towards military drones but can also be applied to manned military aircraft. Presenting a system where aircraft can be connected in flight to extend drone range.

### Description of the Related Art

Drone aircraft generally fly independently from the point of origin to a destination point with engines running continuously throughout flight to the point of destination.

### SUMMARY OF THE INVENTION

Disclosed is a drone system and method for connecting drone aircraft in flight via connecting rods mounted to the drone aircraft. This allows a group of drone aircraft to significantly extend their range by temporarily turning off the engines of one or more of the drone aircraft in flight while connected via the connecting rods.

Other features and aspects will be apparent from the following detailed description, the drawings, and the claims

### BRIEF DESCRIPTION OF THE DRAWINGS

FIG. 1A shows in one embodiment a single drone with connecting rods.

FIG. 1B shows one embodiment of a connecting rod assembly.

FIG. 2A illustrates a side view of one embodiment of a group of connected drone aircraft.

FIG. 2B shows a bottom view of one embodiment of connected drone aircraft.

FIG. 3A depicts one embodiment of two drones in flight prior to connecting.

FIG. 3B shows a closeup of one embodiment of a connecting rod assembly.

FIG. 3C shows a closeup head-on view of one embodiment of a receiving unit.

FIG. 3D shows one embodiment of a extending rod unit.

FIG. 3E shows bottom view of two aircraft preparing to connect.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

The disclosed systems and methods provide drone aircraft systems and methods that allow drone aircraft to significantly extend the distance or range that they are able to travel without refueling. The disclosed systems and methods provide drone aircraft that include a plurality of connecting rod assemblies to connect the drone aircraft in-flight. The connecting rods may be connected to the bodies of the drone aircraft, and in one embodiment, at or near the bottom of the body of the aircraft.

The systems and methods thereby provide drone systems with the capability of attaching drones to another of a plurality of drones, in one embodiment directly in front of or behind the other drone in single-file fashion, while in flight. The number of drones that may be interconnected in this manner can be two or more depending on the specifics of the drone aircraft. In one example, the aircraft may be military style drones capable of flying combat or reconnaissance missions.

In the disclosed methods and systems, the plurality of drone aircraft can fly from one geographic point to a second geographic point while using less fuel than would be possible when flying the drones independently. A geographic point as used herein is a unique point on or above the earth's surface.

The drones take off independently, and after achieving sufficient cruising speed, maneuver to connect to other drone aircraft with the connecting rods. While connected with the connecting rods, only the trailing aircraft has engines turned on. The remaining connected drone aircraft turn their engines off thereby conserving fuel. At particular flight intervals the drone aircraft may detach, reconfigure, and then re-attach with a different drone as the trailing aircraft. The trailing aircraft will then again keep its engines turned on while the remaining drone connected via the connecting rods will turn their engines off. This process may be done once or a plurality of times.

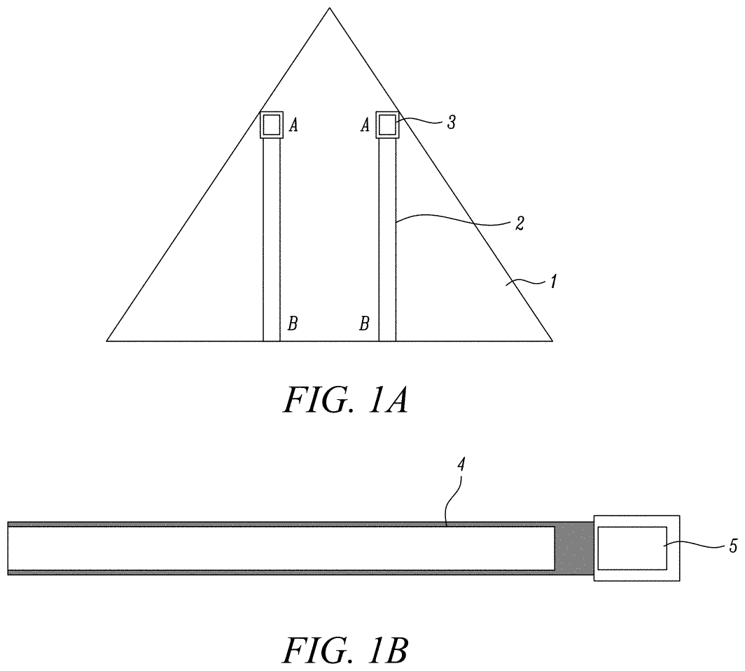

FIG. 1A shows a single drone 1 with connecting rod assemblies 2 mounted to the underside of the drone aircraft. This placement of connecting rod assemblies is only one example, and other placements of the connecting rod assemblies on the body of the drone aircraft are contemplated. The connecting assemblies may include a latching\locking feature. The connecting rod assemblies further include a housing 3 which houses extending and retracting arm components.

FIG. 1B shows one embodiment of a connecting rod assembly 2. The connecting rod assembly includes extending and retracting component 4 and receiving component 5.

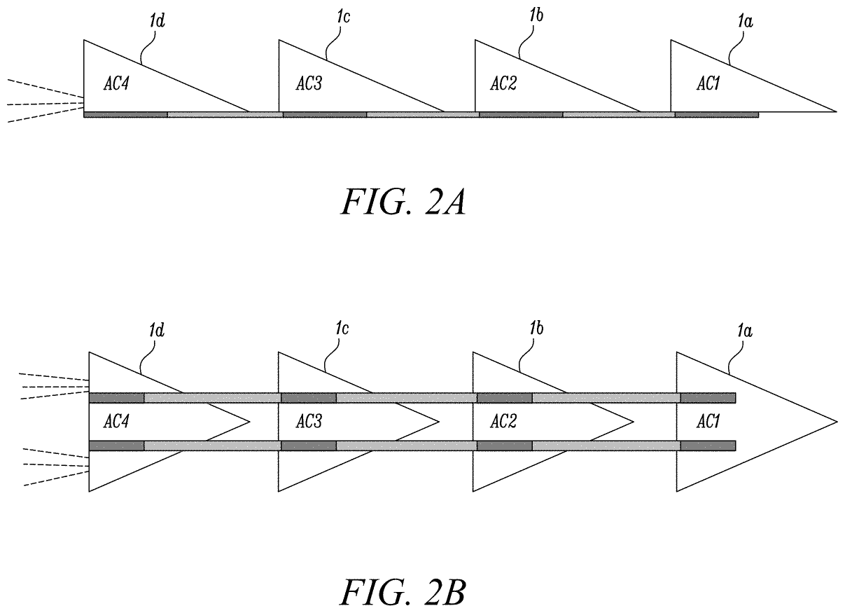

FIG. 2A shows a side view of one embodiment of a group of drone aircraft 1a, 1b, 1c, 1d connected via connecting rods assemblies 2 in flight. The drone aircraft are here represented generically and may be of the same or different type, design, make, or model, etc.

FIG. 2B shows a bottom view of the drone aircraft 1 connected via the connecting rod assemblies 2 in-flight.

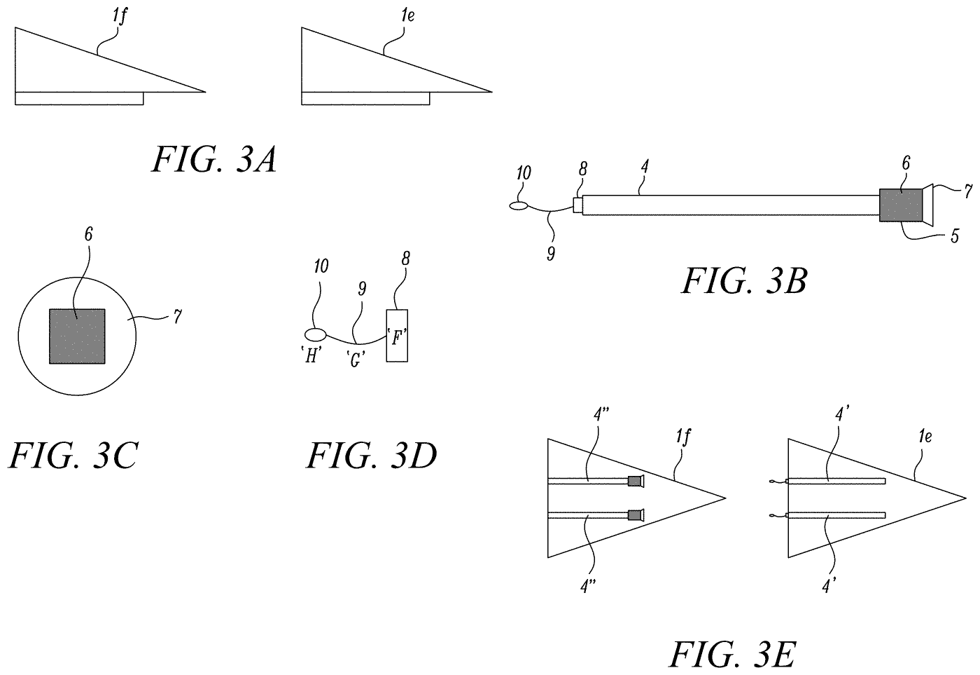

FIG. 3A shows a side view of two aircraft 1e, 1f, preparing to connect. Connecting drone 1f lines up behind target drone 1e at a specified distance determined to be safe and appropriate to achieve connection. Both drones 1f and 1e maintain approximately the same altitude in flight. FIG. 3B shows a close-up view of a connecting rod assembly 4. FIG. 3 shows receiving unit with latching mechanism 6 and funnel-shaped area 7. Connecting rod assembly 4 includes a servo motor 8, cable 9 (which may be semi-flexible) and ball 10. Servo motor 8 at end of connecting rod 4 may be launched to commence a connection sequence. FIG. 3D shows a close-up view of servomotor 8, cable 9, and ball 10. Cable 9 and servo-motors 8 operate continuously in the XY axis to position ball 10 to center of receiving unit 6.

FIG. 3C shows a close-up view of receiving unit 6 and a funnel shaped area 7. Receiving unit 6 with a latching mechanism (not shown) presents a target for ball 10. To facilitate homing and connection, ball 10 hitting funnel-shaped area 7, directs ball 10 towards center of receiving unit 6. When ball 10 and achieves an appropriate depth, a clamping unit (not shown) engages. When both units are engaged, cable 9 begins to retract drawing extending rods (not shown) into receiving component 6 until fully engaged. At the end of this sequence, cable 9 is fully retracted to the home position extending segment of extending rods of connecting rod assembly 4 to be fully extended and clamped to receiving unit 6.

FIG. 3E shows a bottom view of drones preparing to connect. When the connection sequence launches, connecting rod assemblies e.g., 4′ and 4″ generally connect on the same side of the respective aircraft 1e, 1f.

While this disclosure includes specific examples, it will be apparent after an understanding of the disclosure of this application has been attained that various changes in form and details may be made in these examples without departing from the spirit and scope of the claims and their equivalents.

What is claimed is:

1. A drone aircraft comprising:
a connecting rod assembly connected to the drone aircraft, wherein the connecting rod assembly includes connecting rods capable of connecting to other drone aircraft in-flight.

2. The drone aircraft of claim 1, wherein the connecting rod assemblies include one or more connecting rods comprising an extending and retracting component, and a receiving component.

3. A method of flying a plurality of drone aircraft from a first geographic point to a second geographic point comprising:
taking off into flight each of the plurality of drone aircraft independently;
achieving a cruising speed and altitude for each of the plurality of drone aircraft;
connecting each of the plurality of drone aircraft to another of the plurality of drone aircraft via one or more connecting rod assemblies into a first configuration;
turning off the engines of each of the plurality of connected drone aircraft except for one trailing drone aircraft out of the plurality of drone aircraft;
flying the first configuration of connected drone aircraft some distance; and
detaching the first configuration of drone aircraft from each other and re-starting the engines of the plurality of drone aircraft that had turned their engines off.

4. The method of claim 3, further comprising:
connecting each of the plurality of drone aircraft to another of the plurality of drone aircraft via one or more connecting rod assemblies into a second configuration with one or more different trailing drone aircraft;
flying the second configuration of connected drone aircraft some distance;
detaching the first configuration of drone aircraft from each other and re-starting the engines of the plurality of drone aircraft that had turned their engines off.

5. The method of claim 3, wherein the first or second configuration of the plurality of drone aircraft includes each drone aircraft connected to other drone aircraft of the plurality of drone aircraft in a single-file configuration.
